(19) United States
(12) Patent Application Publication
(10) Pub. No.: US 2021/0091565 A1
(43) Pub. Date: Mar. 25, 2021

(54) SYSTEMS AND METHODS FOR CONTROLLING DISTRIBUTED POWER SYSTEMS USING DOWN-SAMPLING

(71) Applicant: General Electric Company, Schenectady, NY (US)

(72) Inventors: Pierino Gianni Bonanni, Loudonville, NY (US); Reza Ghaemi, Watervliet, NY (US); Masoud Abbaszadeh, Clifton Park, NY (US)

(21) Appl. No.: 16/577,791

(22) Filed: Sep. 20, 2019

(51) Int. Cl. H02J 3/00; G05B 13/04

(52) U.S. Cl. CPC H02J 3/00; H02J 2003/007; G05B 13/048

(57) ABSTRACT

A method for controlling a distributed power system is provided, the power system including an aggregator communicatively coupled to a plurality of nodes. The method includes receiving, at the aggregator, a specified aggregated power level, and at each of a plurality of sample times recurring at a regular interval, receiving, at the aggregator from each of the nodes, a condensed dataset, calculating, at the aggregator, a global value based on the specified aggregated power level, the condensed datasets, and a control prediction horizon, transmitting the global value to each of the nodes, solving, at each of the plurality of nodes, a local optimization problem based on the received global value and a local model prediction horizon for that node that is longer than the control prediction horizon, and controlling, at each of the plurality of nodes, a load based on the solved local optimization problem.

### STATEMENT REGARDING FEDERALLY SPONSORED RESEARCH AND DEVELOPMENT

This invention was made with Government support under contract number DE-AR0000698 awarded by ARPA-E. The Government has certain rights in this invention.

### BACKGROUND

The subject matter described herein relates generally to power distribution systems and, more particularly, to load (demand) side power grid control.

The power generation industry is transitioning from being primarily based on a small number of large centralized power plants to a diversified network that combines conventional power plants, renewable power generation (e.g., solar, wind and the like), energy storage and microgrids. Traditionally, power grids have been designed to accommodate variable load demand, in which central-station power plants at a transmission level provide services down to the industrial, commercial, and residential end users at a distribution level.

As renewable energy is becoming a major contributor in meeting demand, grid control systems need to provide more flexibility for power systems to compensate for the volatility of renewable energy. More particularly, due to uncertainties in renewable energy resource availability, renewable power generation cannot be accurately forecast.

To facilitate the penetration of renewable power generation (such as wind turbines and solar panels) into the power grid, load-side control is used. In general, the purpose of load-side control is to attempt to optimize the collective power consumption of the loads (such as buildings), including to accommodate uncertainties in the renewable power generation.

### BRIEF DESCRIPTION

In one aspect, a method for controlling a distributed power system is provided, the power system including an aggregator communicatively coupled to a plurality of nodes, each of the plurality of nodes including an associated load. The method includes receiving, at the aggregator, a specified aggregated power level from an independent service operator, and at each of a plurality of sample times recurring at a regular interval, receiving, at the aggregator from each of the plurality of nodes, a condensed dataset including load-specific information for that node, calculating, at the aggregator, a global value based on the specified aggregated power level, the plurality of condensed datasets, and a control prediction horizon, wherein the control prediction horizon is a time period that is an integer multiple of the regular interval, transmitting the global value to each of the plurality of nodes, solving, at each of the plurality of nodes, a local optimization problem for that node based on the received global value and a local model prediction horizon for that node, wherein the local model prediction horizon for at least one node of the plurality of nodes is longer than the control prediction horizon, and controlling, at each of the plurality of nodes, the load based on the solved local optimization problem for that node.

In another aspect, a distributed power system is provided. The distributed power system includes a plurality of nodes, each node including an associated load, and an aggregator communicatively coupled to the plurality of nodes, the aggregator configured to receive a specified aggregated power level from an independent service operator, and at each of a plurality of sample times recurring at a regular interval, receive from each of the plurality of nodes, a condensed dataset including load-specific information for that node, calculate a global value based on the specified aggregated power level, the plurality of condensed datasets, and a control prediction horizon, wherein the control prediction horizon is a time period that is an integer multiple of the regular interval, and transmit the global value to each of the plurality of nodes. Each of the plurality of nodes is configured to, at each of the plurality of sample times, solve a local optimization problem for that node based on the received global value and a local model prediction horizon for that node, wherein the local model prediction horizon for at least one node of the plurality of nodes is longer than the control prediction horizon, and control the load based on the solved local optimization problem for that node.

In yet another aspect, a node for use in controlling a distributed power system is provided. The node has an associated load and is communicatively coupled to an aggregator. The node includes a memory device, and a processor communicatively coupled to the memory device, the processor configured to, at each of a plurality of sample times recurring at a regular interval, receive, from the aggregator, a global value, wherein the global value is calculated by the aggregator based on a specified aggregated power level received from an independent service operation, a condensed dataset including load-specific information for the node, and a control prediction horizon, wherein the control prediction horizon is a time period that is an integer multiple of the regular interval, solve a local optimization problem based on the received global value and a local model prediction horizon for the node, wherein the local model prediction horizon for the node of the plurality of nodes is longer than the control prediction horizon, and control the load based on the solved local optimization problem for the node.

### DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an exemplary environment in which an aggregator load structure communicates with nodes corresponding to controlled loads.

FIG. 2 is an exemplary block/data flow diagram representing a controller communicating information with an aggregator to iteratively converge towards an optimal solution.

FIG. 3 is a flow diagram showing exemplary operations of an iterative, distributed power control technology.

FIGS. 4 and 5 are a flow diagram showing exemplary operations of an aggregator.

FIGS. 6 and 7 are a flow diagram showing exemplary operations of a per-load distributed controller.

FIG. 8 is a flow diagram showing exemplary operations for controlling a discrete load.

FIG. 9 is a graph 900 illustrating operation of a down-sampling scheme that may be implemented using the environment shown in FIG. 1.

FIG. 10 is a flow diagram of an exemplary method for controlling a distributed power system in accordance with a down-sampling scheme.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about,” “substantially,” and “approximately,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

The systems and methods described herein enable controlling a distributed power system that includes an aggregator communicatively coupled to a plurality of nodes, each of the plurality of nodes including an associated load. The aggregator receives a specified aggregated power level from an independent service operator. At each of a plurality of sample times recurring at a regular interval, the aggregator receives, from each of the plurality of nodes, a condensed dataset including load-specific information for that node. The aggregator calculates a global value based on the specified aggregated power level, the plurality of condensed datasets, and a control prediction horizon, wherein the control prediction horizon is a time period that is an integer multiple of the regular interval, and transmits the global value to each of the plurality of nodes. Each of the plurality of nodes solves a local optimization problem for that node based on the received global value and a local model prediction horizon for that node, wherein the local model prediction horizon for at least one node of the plurality of nodes is longer than the control prediction horizon, and controls the load based on the solved local optimization problem for that node.

Various aspects of the technology described herein are generally directed towards distributed load-side power control. In the embodiments described herein, the technology includes a distributed optimization approach for control of an aggregation of distributed flexibility resources (DFRs, which may be referred to as nodes), such that a commanded power profile (e.g., specified by an independent service operator) is produced by aggregated loads. In general, and as will be understood, the technology is based on a distributed iterative solution to solve a network utility maximization problem. Distributed load-side power control systems are described in detail in U.S. patent application Ser. No. 15/462,136, filed Mar. 17, 2017, and International Application No. PCT/US2018/050903, filed Sep. 13, 2018, both of which are incorporated by reference herein in their entirety.

In general, each distributed flexibility resource node solves a local optimization problem with its own local constraints (e.g., limits on temperatures on zones within a building) and states. However, the cost function incorporates a global (that is, shared by all nodes) Lagrange multiplier to augment information from the full set of distributed nodes, to track the need for additional power (via a reserve request signal) as an aggregate entity. To this end, the global Lagrange multiplier is calculated at an aggregation level using information that is gathered from each node, with the newly calculated global Lagrange multiplier, associated with the constraint that requests that aggregated power needs to equal the command power generated by an independent service operator, broadcast to each node. The operations are iterative; each node uses the received Lagrange multiplier to perform one iteration of an optimization algorithm that calculates the search direction using the given Lagrange multiplier and sends updated information to an aggregator, which then recalculates a new Lagrange multiplier from the updated information, broadcasts the new Lagrange multiplier to the nodes for a next optimization iteration, and so on, until the aggregator determines that a sufficient level (some defined level) of convergence is reached. This procedure is performed at each sample time and once convergence occurs, loads apply the computed optimal control.

It should be understood that any of the examples herein are non-limiting. As such, the technology described herein is not limited to any particular implementations, embodiments, aspects, concepts, structures, functionalities or examples described herein. Rather, any of the implementations, embodiments, aspects, concepts, structures, functionalities or examples described herein are non-limiting, and the technology may be used in various ways that provide benefits and advantages in power control concepts in general.

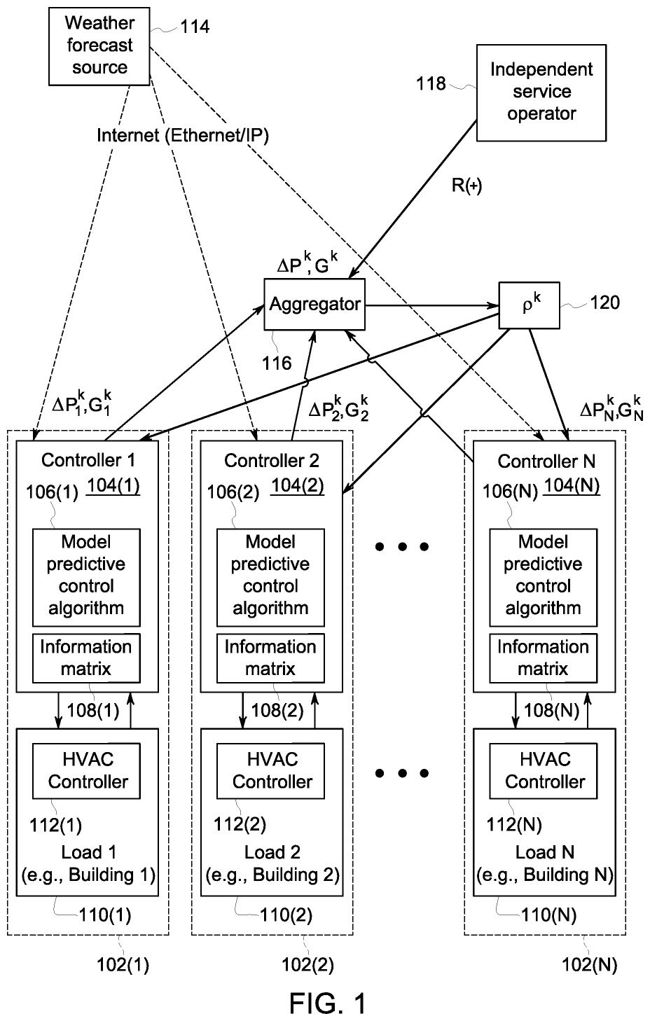

In general and as represented in FIG. 1, a number of (distributed flexibility resource) nodes 102(1)-102(N) are managed as described herein with respect to power control. There may be any practical number of nodes, possibly on the order of millions.

Represented nodes 102(1)-102(N), include controllers 104(1)-104(N) having model predictive control algorithms 106(1)-106(N) and information matrixes 108(1)-108(N) that describe the local states and constraints of the node. One example state is a local weather forecast obtained from a source 114 such as the National Oceanic and Atmospheric Administration (NOAA), as the weather influences renewable power source output as well as corresponds to how much power a node is likely to need for heating or cooling, for example. Other state that may be maintained may be room temperatures, zone temperatures, heating and cooling characteristics, time of day, day of week and so on.

Nodes 102(1)-102(N) are also shown in FIG. 1 as including loads 110(1)-110(N), which are controllable by heating, ventilation and air conditioning (HVAC) controllers 112(1)-112(N), respectively. A typical example of a load is a building, however it is understood that a building or the like may correspond to multiple, separate loads (e.g., separate nodes), and/or multiple buildings or the like may correspond to a single load (node).

Nodes 102(1)-102(N) are coupled via their respective controllers 104(1)-104(N) to an aggregator 116. As will be appreciated by those of skill in the art, aggregator 116 may be implemented as a computing device that includes a processor communicatively coupled to a memory device. In general and as described herein, aggregator 116 receives a commanded power profile from an independent service operator (ISO) 118, and uses that information along with local load-specific information received from each controller 104(1)-104(N) to compute a global Lagrange multiplier 120 mathematically represented by ρ^{k} (at iteration k). Global Lagrange multiplier 120 computed by aggregator 116 is sent to controllers 104(1)-104(N), for use by each controller in solving its local optimization problem.

To summarize thus far, the technology is directed towards attempting to more optimally control distributed flexibility resource nodes, such that the aggregated power tracks a commanded power profile that comes from ISO 118. The optimization problem is solved in a distributed way, where each distributed flexibility resource node exchanges data with the aggregator and performs one optimization iteration according to the distributed optimization scheme described herein to solve the global model predictive control optimization problem in a tractable fashion.

In the exemplary embodiment, the modified local cost function is the sum of a local cost (local utility function) and a Lagrange multiplier times the power consumed (supplied) by the distributed flexibility resource. The value of Lagrange multiplier 120 that is shared among nodes 102(1)-102(N) is calculated at the aggregator level. At aggregator 116, the Lagrange multiplier is a function of the commanded power profile and the local data that are sent to aggregator 116 at each iteration of optimization. The recalculated Lagrange multiplier is sent back to the nodes to be used in the cost for next iteration, and so on. As the nodes iterate synchronously, they converge towards an acceptable solution (that is, to a defined/predetermined convergence threshold) to the network/global Model Predictive Control optimization problem through the aforementioned iterative distributed computation scheme.

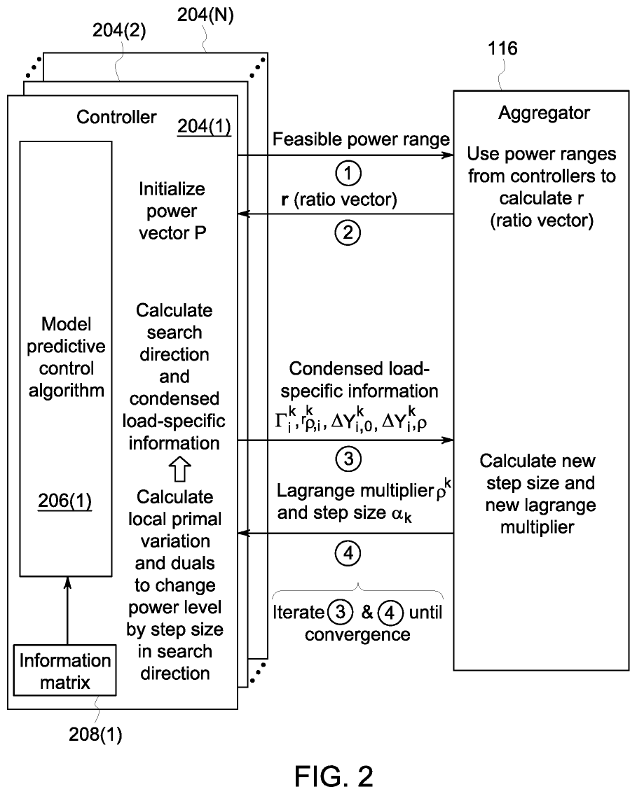

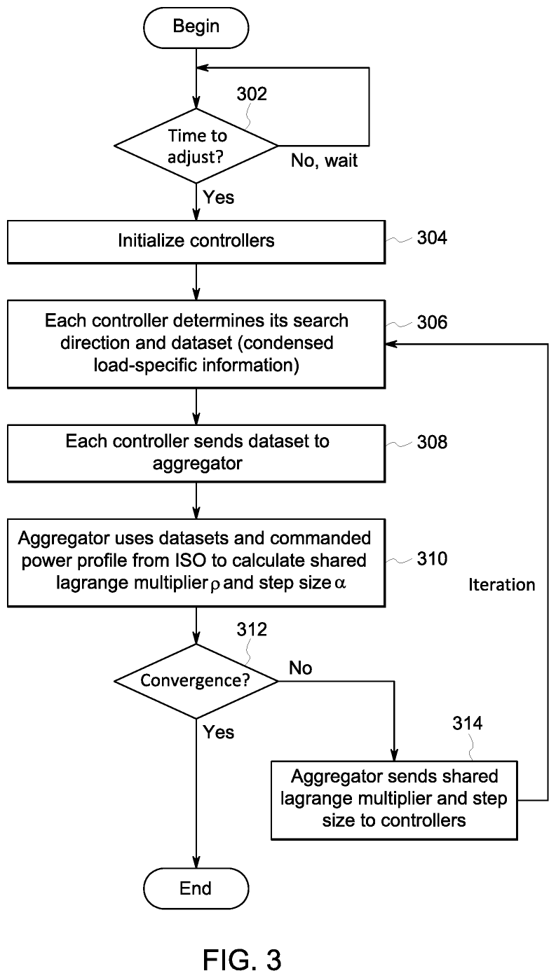

As represented in FIG. 2 for an exemplary controller instance 204(1) (of a set of controller instances 204(1)-204(N)), the iterative distributed scheme can be described in the following operations, also exemplified in the flow diagram of FIG. 3. At a time to adjust (represented by operation 302 of FIG. 3), such as once per minute, each of the controllers are initialized (represented by labeled arrows one (1) and two (2) in FIG. 2, and also by operation 304 of FIG. 3). In general, and as further described herein, controller 204(1) sends its feasible power range to aggregator 116, which then uses the feasible power ranges of the various controller instances 204(1)-204(N) to compute a ratio (e.g., a vector r) for each controller. This ratio is used to compute an initial power vector at each load (operation 304 of FIG. 3).

Once initialized, the communications represented by labeled arrows three (3) and four (4) in FIG. 2, and operations 306, 308, 310, 312 and 314 of FIG. 3 are performed iteratively. At operation 306, each controller solves the local nonlinear programming problem for the search direction as described below. As a side product, a set of data comprising load-specific information (a dataset in condensed form) is also generated and sent to aggregator 116 (arrow three (3) in FIG. 2, operation 308 in FIG. 3).

At the aggregator, at operation 310, using the data collected from the nodes and the commanded power profile from the independent service operator, the shared Lagrange multiplier is calculated, along with a step size. If convergence to the desired, defined level is not yet achieved (operation 312), the Lagrange multiplier and step size are sent to the nodes (arrow four (3) in FIG. 2 and operation 314 in FIG. 3).

Using the new value of the Lagrange multiplier, a new search direction and an updated dataset is calculated by iteratively returning to step 306. The updated dataset is sent from controller 204(1) to aggregator 116 (arrow three (3) in FIG. 2 and operation 308 in FIG. 3. The aggregator computation at operation 310 and the broadcast to the nodes at operation 314 is repeated and so on, until the convergence is detected at operation 312.

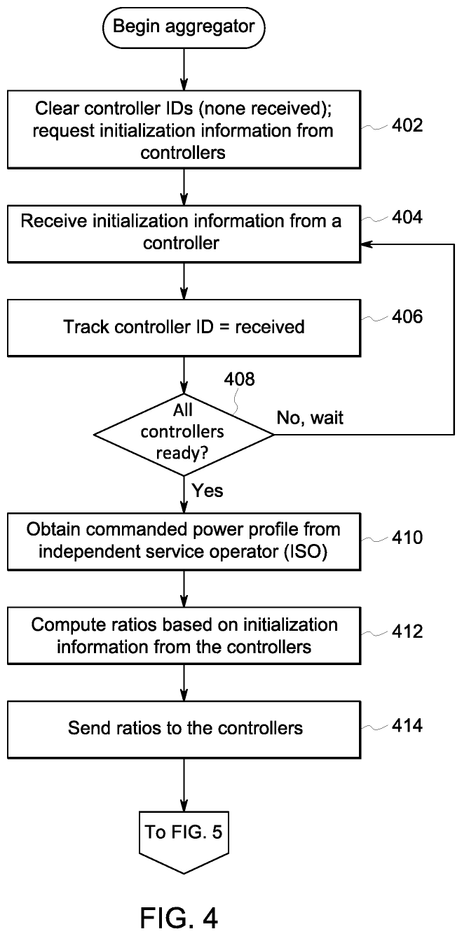

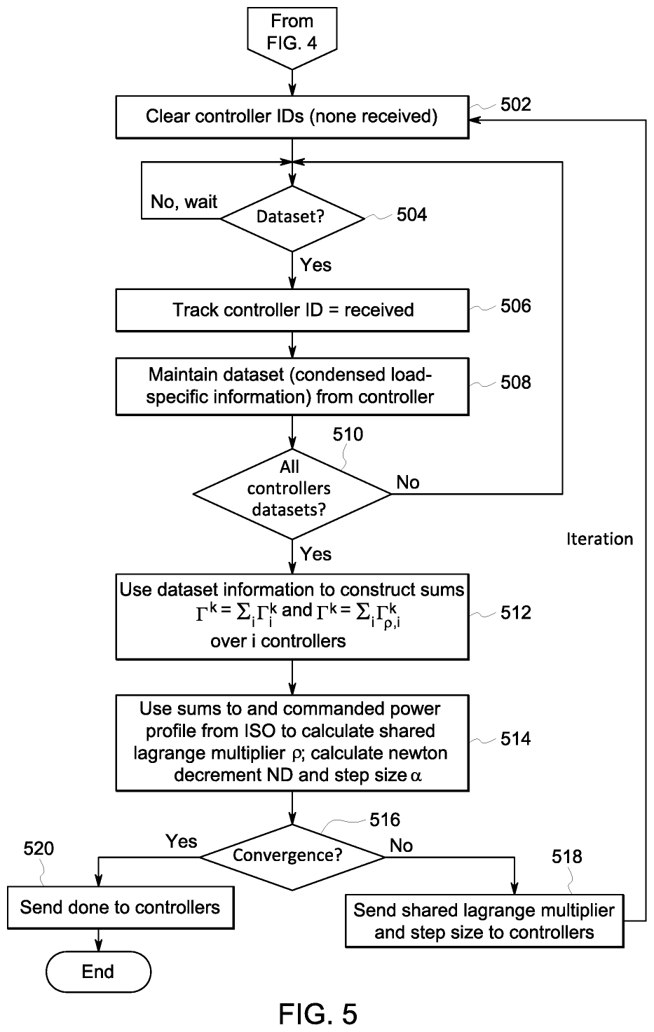

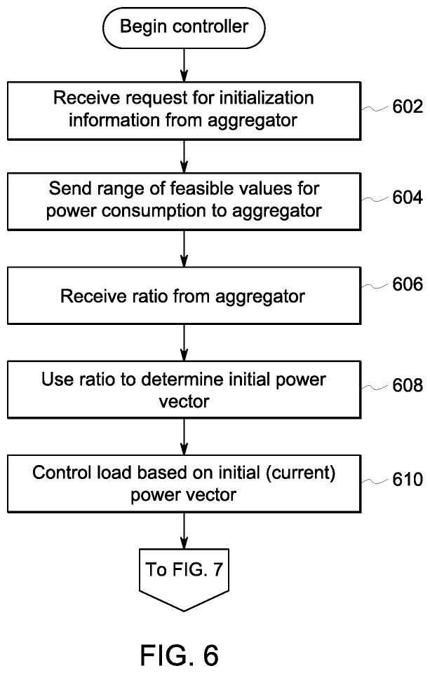

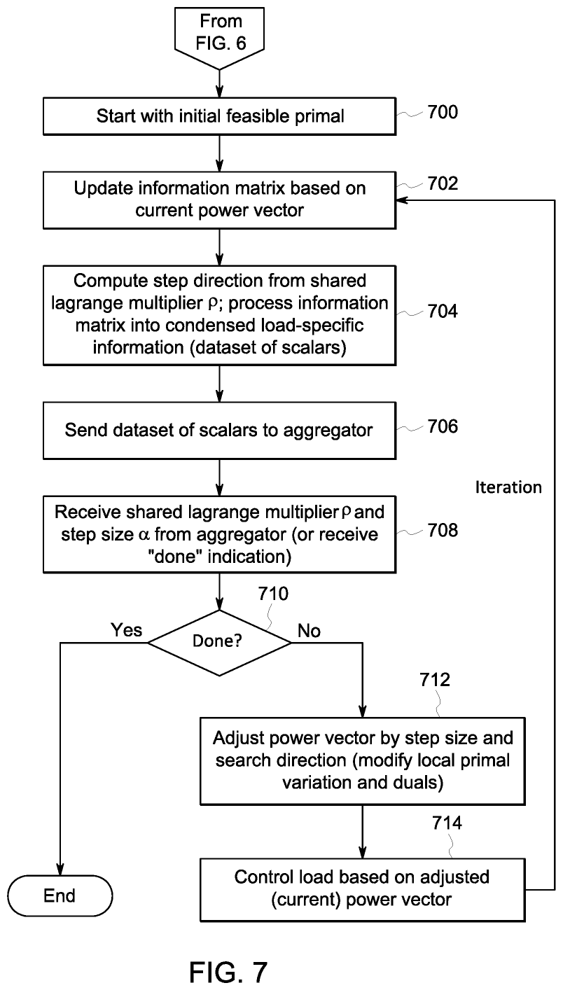

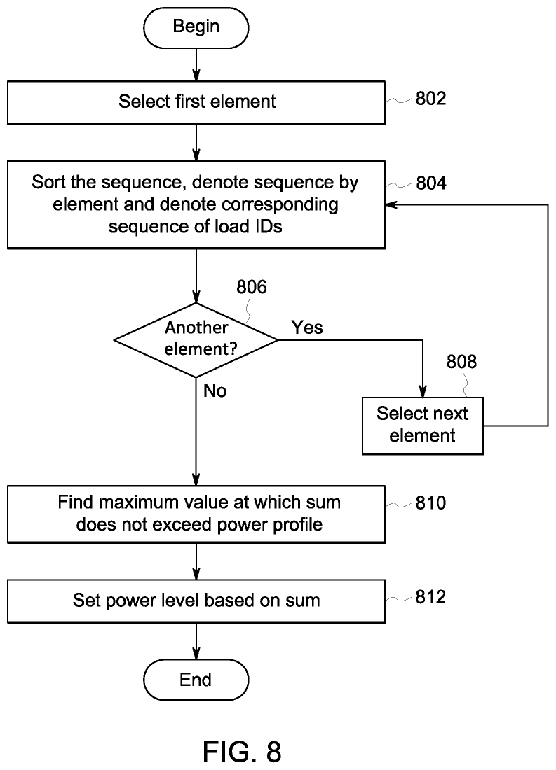

FIGS. 1 and 2 describe the communication structure of aggregator 116 and nodes through which the Newton direction and step size are calculated. In the exemplary embodiment, as described in FIG. 3, the operations occur in two general stages. A first stage is feasible initialization, described herein with reference to the flow diagrams of FIG. 4 (the aggregator initialization-related operations) and FIG. 6 (the controller initialization-related operations), where each load is initialized by the power that is locally feasible and satisfies the power balance constraint (eq. 5c). A second stage is optimization iterations, described herein with reference to the flow diagrams of FIG. 5 (the aggregator optimization-related operations) and FIG. 7 (the controller optimization-related operations).

The initialization phase may, in one or more implementations, be started by aggregator 116 initializing itself and requesting that each controller 204 provide power feasible information (operation 402 of FIG. 4 and operation 602 of FIG. 6).

For each load Lᵢ∈ [symbol] , a range (interval) [pₘᵢₙⁱ,pₘₐₓⁱ] is assumed which defines the feasible values for power consumption. Hence, each of loads 110 sends its respective upper and lower limit of the power feasible range to aggregator 116 (operation 604 of FIG. 6).

Operations 404, 406 and 408 of FIG. 4 represent collecting the initial range information from each of controllers 204. When the range information is received at aggregator 116 from controllers 204, Pₘᵢₙ=Σᵢ pₘᵢₙⁱ and Pₘₐₓ=ΣᵢPₘₐₓⁱ are calculated; (note that it is feasible to begin summing before each of controllers 204 has responded). Further note that if the desired values of some elements of P_{d} do not belong to [Pₘᵢₙ,Pₘₐₓ] then the constraint (eq. 5c) is not feasible. Otherwise, assuming p_{d}^{j} is the j-th element of P_{d}, the ratio vector r is calculated as

$${r}_{j} := \frac{{p}_{d}^{j} - {P}_{min}}{{P}_{max} - {P}_{min}}$$

where rⱼ is the j-th element of r. The value of r is then sent to controllers 204, which may differ per controller. Note that the value of r corresponds to the target power obtained from the independent service operator, (operation 410), which may be obtained independently at any suitable time before the ratios are computed and sent (operations 412 and 414).

When the ratio vector is received by a controller (operation 606 of FIG. 6), at each load Lᵢ, the power vector Pᵢ is initialized by setting its j-th element of it as Pᵢ^{j}=pₘᵢₙⁱ+rⱼ(pₘₐₓⁱ−pₘᵢₙⁱ) (operation 608 of FIG. 6). The controlling of the load based upon this initial power vector (which is the current power vector at this time) is represented by operation 610 of FIG. 6).

The optimization phase is described herein with reference to the flow diagrams of FIG. 5 (the aggregator optimization-related operations) and FIG. 7 (the controller optimization-related operations). For example, aggregator 116 clears its tracking information (that assures each controller 204 reports its data) and waits for controllers 204 to begin sending their datasets until each is received, as represented by operations 502, 504, 506, 508, and 510 of FIG. 5.

Each controller 204 starts with its own initial feasible primal Y⁰ (e.g., operation 700 of FIG. 7, not part of the iterations). Note that operation 702 represents updating the information matrix for that node, which may occur independent of any controller operations, e.g., as the power vector changes.

At each load Lᵢ, operation 704 is performed, which calculates the step direction and also generates the quantities that represent the information matrix in condensed form. These per-node dependent values are sent to aggregator 116 by each controller 204 at operation 706 of FIG. 7.

Aggregator 116, as represented by operation 512 of FIG. 5, constructs Γ^{k}=ΣᵢΓᵢ^{k} and rₚ^{k}=Σᵢr_{ρ,i}^{k}, note that the summations may begin before each controller 204 has reported its dataset. Aggregator 116, as represented by operation 514 of FIG. 5, calculates ρ^{k} using (eq. 8), calculates the Newton decrement, ND(Y^{k})=\sqrt{Σᵢ(αᵢ^{k}ρ^{k}^{²}+2bᵢ^{k}ρ^{k}+cᵢ^{k})}, and calculates αₖ according to (15). If the value of ND (i^{k}) is sufficiently small, as based upon a predefined convergence level, operation 516 terminates the iterations. Otherwise, operation 518 sends ρ^{k} and αₖ to controllers 204.

At each controller 204, if ρ^{k} and αₖ are received (operations 708 and 710 of FIG. 7), ρ^{k} and αₖ are used to calculate the local primal variation and duals according to (eq. 11) and update the primal according to (eq. 6); (operation 712 of FIG. 7. This changes the power control of the load (step 714). Note that operation 710 represents receiving a “done” indication from the aggregator, which is not strictly necessary if operation 708 does not receive anything further, until operation 602 restarts the next controller initialization.

Turning to another aspect, some loads have discrete power consumption, that is, are either on or off (in contrast to loads that accept continuous values for power control). Described herein is an algorithm that can handle loads that only accept boundary values of the power feasible interval (assuming the interval is the range from minimum to maximum). Thus, the power only accepts discrete values, e.g., pᵢ∈{pₘᵢₙⁱ,pₘₐₓⁱ} for the loads Lᵢ∈ [symbol] _{d}⊂ [symbol] . A general goal here is to avoid mixed-integer programming, which is often not suitable for real time optimization, especially for large scale problems.

To this end, the optimization problem is first solved according to the algorithm assuming all the loads accept continuous values for power within the feasible interval. Let {P̅ᵢ} be the sequence of optimal power vectors and P_{dsc}:= [symbol] P̅ᵢ be the power consumed by loads with discrete power consumption. Further, let N_{dsc}=| [symbol] _{d}| be number of the loads with discrete power input. The following algorithm turns the value of elements of P̅ᵢ to pₘₐₓⁱ of pₘᵢₙⁱ so that the desired power P_{d} is tracked as close as possible while the power values closer to maximum have higher priority to be switched to pₘₐₓⁱ.

Via operations 802, 806 and 808, for each element j, which represents the j-th step in the prediction horizon, operation 804 sorts the sequence

$$\{ \frac{{p}_{max}^{i} - {\overline{p}}_{i}^{j}}{{p}_{max}^{i} - {p}_{min}^{i}} \}$$

and denotes it by {\hat{P}ᵢ}. Also, operation 804 denotes the corresponding sequence of the load numbers by I.

Operation 810 finds the maximum value of nⱼ such that Σᵢ₌₁ⁿ^{ⱼ}Pₘₐₓ^{I}^{ᵢ}≤P_{d}^{j}. Operation 812 sets P_{I}_{ₖ}^{j}=pₘₐₓ^{I}^{ₖ}, for k=1, . . . , nⱼ and sets the rest to pₘₐₓ^{I}^{ₖ}.

Combining the continuous load optimization with the above-described discrete load post-processing allows the technology to handle any mixture of continuous and discrete loads.

In some embodiments, the distributed optimization scheme may be formulated as a predictive control problem, with one or more nodes 102 having individual and separate prediction horizons for model output and control action, referred to herein as a model prediction horizon and a control prediction horizon, respectively. The separation of the model prediction horizon from the control prediction horizon enables using relatively large model prediction horizons for slower nodes 102, while still maintaining the same control prediction horizon at aggregator 116. This keeps computational demands relatively low, and suitable for real-time applications. Further, this allows for different nodes 102 to have different model prediction horizons for different loads 110, and for a model prediction horizon for a particular node 102 to vary over time, as described herein.

In the systems and methods described herein, down-sampling is used to extend model prediction horizons for nodes 102. Specifically, suppose that the sample time is Tₛ, and that the control prediction horizon utilized by aggregator 116 has Nₚ control steps. For each node 102, associated controller 104 uses a down-sampling factor Kₚ to modify the time value of each prediction step in the model prediction horizon for that node 102 to Kₚ times the sample time Tₛ. That is, each controller 104 solves its local optimization problem relative to a model prediction horizon that is discretized for an adjusted sample time Kₚ*Tₛ, instead of Tₛ. This permits extended prediction look-ahead at nodes 102 while still computing Nₚ control steps, thereby keeping the computational burden relatively low. Specifically the model output prediction horizon is extended to Kₚ*Nₚ*Tₛ minutes. Further, this down-sampling scheme is equivalent to employing a model discretized by the sample time Tₛ, but repeating each input value for Kₚ steps.

For example, assume the sampling time Tₛ is one minute, and assume the number of control steps Nₚ is ten. Without using the down-sampling factor, the control prediction horizon utilized by aggregator 116 and the model prediction horizon used by a node 102 have the same length, ten minutes (i.e., one minute multiplied by ten steps). However, if a down-sampling factor Kₚ of three is used for the node 102, the control prediction horizon will still have a length of ten minutes, but the model prediction horizon for the node 102 will now be thirty minutes (i.e., one minute multiplied by ten steps, multiplied by the down-sampling factor of three).

Accordingly, each sample in the model prediction has a duration of Kₚ steps. The down-sampling factor is acceptable, and provides computational advantages, as long as a shortest time constant for asset response is still much greater than Kₚ*Tₛ.

The advantages of the down-sampling scheme are achievable with any positive integer valued model prediction horizon of Mₚ steps that is larger than the control prediction horizon of Nₚ steps. However, to simplify the scheme, in the exemplary embodiment, the model prediction horizon steps Mₚ are an integer multiple (i.e., the down-sampling factor Kₚ) of the control prediction horizon steps Nₚ. Accordingly, the predictive model for each node 102 is discretized using an adjusted sample time Kₚ*Tₛ, while the sample time utilized by aggregator 116 remains as Tₛ. The down-sampling factor Kₚ for each node 102 may be a predetermined value and be stored, for example, in associated controller 104. Alternatively, the down-sampling factor Kₚ for each node 102 may be dynamically calculated in real-time (e.g., using associated controller 104). Further the down-sampling factor Kₚ for each node 102 may change over time.

With control prediction horizon steps Nₚ and model prediction horizon steps Mₚ, Mₚ=Kₚ*Nₚ. Accordingly, the model prediction horizon is longer than the control prediction horizon. The distributed optimization algorithm still computes only Nₚ control actions, but those actions impact over the model prediction horizon, which is Kₚ times longer than the control prediction horizon. This is equivalent to having a control prediction horizon having the extended length of the model prediction horizon, but with each control action applied for Kₚ consecutive samples.

For example, suppose the down-sampling factor Kₚ is three and the number of control prediction horizon steps Nₚ is two. In this example, the following mathematical relationships may be defined: U=[u₁ u₂]^{T}, Y=[y₁, y₂, . . . , y₆]^{T}, and U=[u₁ u₁ u₁ u₂ u₂ u₂]^{T}, where U is a vector of future control actions to be computed by the distributed optimization algorithms, Y is a vector of future model outputs, and U is a fictitious equivalent future control action vector with the same horizon as the model prediction horizon. Accordingly, despite computing only two future control actions (i.e., because Nₚ is two), with a Kₚ of three, node 102 solves its local optimization problem based on a model prediction horizon of six samples (i.e., because Mₚ is six). Although this is mathematically equivalent to computing a control action horizon with a sample length equal to the model prediction horizon (but constrained to the form of U), this scheme requires 1/Kₚ fewer computations, improving the suitability of the technique for large-scale, real-time applications.

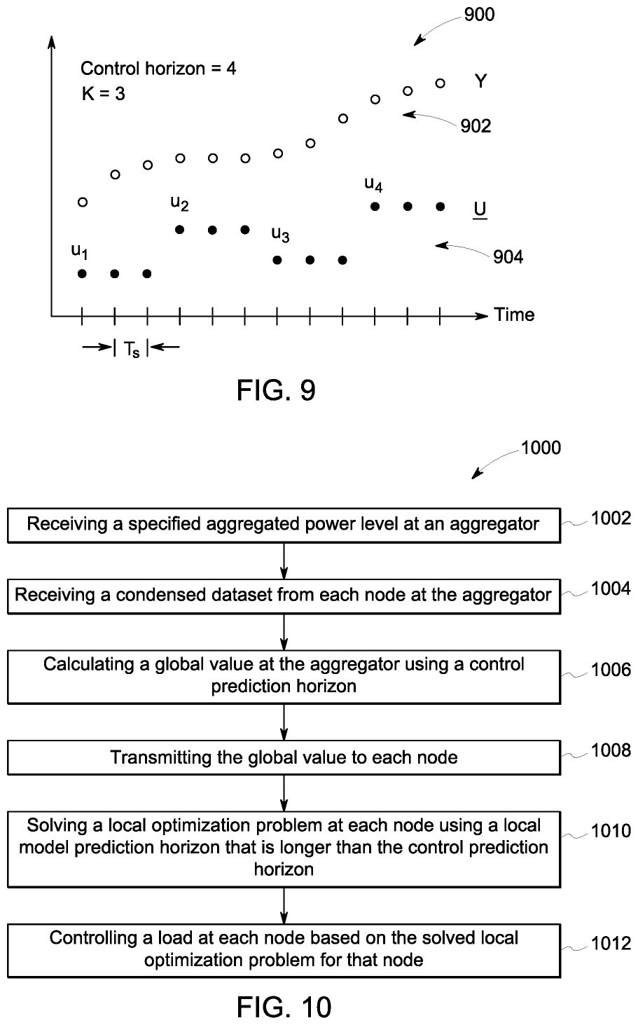

FIG. 9 is a graph 900 illustrating operation of the down-sampling scheme described herein. In this example, the number of control prediction horizon steps Nₚ is four and the down-sampling factor Kₚ is three. Graph 900 includes an output sequence 902 and a control sequence 904. As shown in FIG. 9, each sequence 902 and 904 includes twelve entries. While the value for output sequence 902 changes at each sample time, the value for control sequence 904 only changes every fourth entry (due to the down-sampling factor Kₚ of three).

FIG. 10 is a flow diagram of an exemplary method 1000 for controlling a distributed power system in accordance with a down-sampling scheme, as described herein. The steps of method 1000 may be implemented, for example, using aggregator 116 and nodes 102 (shown in FIG. 1). Method 1000 includes receiving 1002, from an ISO, such as ISO 118 (shown in FIG. 1), a specified aggregated power level. At each of a plurality of sample times recurring at a regular interval, method 1000 further includes receiving 1004, at aggregator 116 from each node 102, a condensed dataset including load-specific information for that node 102. The regular interval may be, for example, sample time Tₛ, as described above. At each sample time, method 1000 further includes calculating 1006, at aggregator 116, a global value. The global value is calculated 1006 based on the specified aggregated power level, the plurality of condensed datasets, and a control prediction horizon. In the exemplary embodiment, the control prediction horizon is a time period that is an integer multiple of the regular interval.

As shown in FIG. 10, method 1000 further includes, at each sample time, transmitting 1008 the global value to each node 102. At each node 102, a local optimization problem is solved 1010 for that node 102 at each sample time. The local optimization problem is solved 1010 based on the global value a local model prediction horizon for that node 102. In the exemplary embodiment, the local model prediction horizon is longer than the control prediction horizon. Further, method 1000 includes, at each sample time, controlling 1012, at each of the plurality of nodes 102, an associated load based on the solved local optimization problem for that node 102.

Relatively large changes in a commanded power level generally benefit from extended model prediction horizons to accommodate pre-cooling and pre-heating with sufficient lead time. However, controllers 104 must also maintain relatively short sample times to reduce reaction time and controller delay when a power setpoint change is received. Large model prediction horizons may add computational burdens, making them generally infeasible for large-scale real-time applications. However, the system and methods described herein address this problem by separating a control prediction horizon from model prediction horizons, and allowing model prediction horizons to differ for different loads 110 based on individual load dynamic response times.

For example, a relatively slow load 110 may take approximately two hundred minutes to adjust to a new power setpoint, whereas a relatively fast load 110 may take approximately ten minutes to adjust to a new power setpoint. Accordingly, it is generally desirable to have a longer model prediction horizon for a slower load 110 and a shorter model prediction horizon for a faster load 110. The systems and methods described herein allow for different loads 110 (and nodes 102) to have different model prediction horizons, allowing for longer model prediction horizons for slower loads 110 and shorter model prediction horizons for faster loads 110.

Operation of the down-sampling scheme described herein was simulated for one hundred loads 110 with large transitions in demanded target power. This is a relatively extreme case, both in terms of power demand levels and timing. For this simulation, the sample time Tₛ was one minute, the number of control prediction horizon steps Nₚ was three, and the down-sampling factor Kₚ was ten (corresponding to a control prediction horizon of three minutes, and a model prediction horizon of thirty minutes). During the simulation, temperatures at loads 110 approached, but did not cross, lower boundaries. Accordingly, the simulation demonstrated successful operation of the systems and methods described herein.

The embodiments described herein include systems and methods for controlling a distributed power system that includes an aggregator communicatively coupled to a plurality of nodes, each of the plurality of nodes including an associated load. The aggregator receives a specified aggregated power level from an independent service operator. At each of a plurality of sample times recurring at a regular interval, the aggregator receives, from each of the plurality of nodes, a condensed dataset including load-specific information for that node. The aggregator calculates a global value based on the specified aggregated power level, the plurality of condensed datasets, and a control prediction horizon, wherein the control prediction horizon is a time period that is an integer multiple of the regular interval, and transmits the global value to each of the plurality of nodes. Each of the plurality of nodes solves a local optimization problem for that node based on the received global value and a local model prediction horizon for that node, wherein the local model prediction horizon for at least one node of the plurality of nodes is longer than the control prediction horizon, and controls the load based on the solved local optimization problem for that node.

An exemplary technical effect of the methods, systems, and apparatus described herein includes at least one of: (a) reducing power mismatch in response to ISO commanded power profiles; (b) reducing power tracking error; (c) improving compliance with regulatory requirements; and (d) improving power tracking in both synchronous and asynchronous systems.

Exemplary embodiments for controlling a distributed power system using a down-sampling scheme are described herein. The systems and methods of operating and manufacturing such systems and devices are not limited to the specific embodiments described herein, but rather, components of systems and/or steps of the methods may be utilized independently and separately from other components and/or steps described herein. For example, the methods may also be used in combination with other electronic systems, and are not limited to practice with only the electronic systems, and methods as described herein. Rather, the exemplary embodiment can be implemented and utilized in connection with many other electronic systems.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for controlling a distributed power system including an aggregator communicatively coupled to a plurality of nodes, each of the plurality of nodes including an associated load, said method comprising:
receiving, at the aggregator, a specified aggregated power level from an independent service operator; and
at each of a plurality of sample times recurring at a regular interval:
receiving, at the aggregator from each of the plurality of nodes, a condensed dataset including load-specific information for that node;
calculating, at the aggregator, a global value based on the specified aggregated power level, the plurality of condensed datasets, and a control prediction horizon, wherein the control prediction horizon is a time period that is an integer multiple of the regular interval;
transmitting the global value to each of the plurality of nodes;
solving, at each of the plurality of nodes, a local optimization problem for that node based on the received global value and a local model prediction horizon for that node, wherein the local model prediction horizon for at least one node of the plurality of nodes is longer than the control prediction horizon; and
controlling, at each of the plurality of nodes, the load based on the solved local optimization problem for that node.

2. The method of claim 1, wherein the local model prediction horizon for the at least one node is equal to the control prediction horizon multiplied by an integral down-sampling factor, Kₚ.

3. The method of claim 2, wherein the control prediction horizon is discretized using the sampling time, and wherein the local model prediction horizon for the at least one node is discretized using the sampling time multiplied by the down-sampling factor.

4. The method of claim 1, wherein the at least one node includes a first node and a second node, wherein the first node has a first local model prediction horizon, wherein the second node has a second local model prediction horizon, and wherein the first local model prediction horizon is different than the second local model prediction horizon.

5. The method of claim 1, further comprising calculating, at the at least one node, the local model prediction horizon based on how quickly the at least one node is able to adjust the power of the associated load.

6. The method of claim 5, wherein the local model prediction horizon is calculated for the at least one node such that a faster node will have a shorter local model prediction horizon than a slower node.

7. The method of claim 1, wherein the local model prediction horizon for the at least one node is a predetermined value stored in a memory device of the at least one node.

8. A distributed power system comprising:
a plurality of nodes, each node comprising an associated load; and
an aggregator communicatively coupled to said plurality of nodes, said aggregator configured to:
receive a specified aggregated power level from an independent service operator; and
at each of a plurality of sample times recurring at a regular interval:
receive from each of said plurality of nodes, a condensed dataset including load-specific information for that node;
calculate a global value based on the specified aggregated power level, the plurality of condensed datasets, and a control prediction horizon, wherein the control prediction horizon is a time period that is an integer multiple of the regular interval; and
transmit the global value to each of said plurality of nodes;
wherein each of said plurality of nodes is configured to, at each of the plurality of sample times:
solve a local optimization problem for that node based on the received global value and a local model prediction horizon for that node, wherein the local model prediction horizon for at least one node of said plurality of nodes is longer than the control prediction horizon; and
control the load based on the solved local optimization problem for that node.

9. The system of claim 8, wherein the local model prediction horizon for said at least one node is equal to the control prediction horizon multiplied by an integral down-sampling factor, Kₚ.

10. The system of claim 9, wherein the control prediction horizon is discretized using the sampling time, and wherein the local model prediction horizon for said at least one node is discretized using the sampling time multiplied by the down-sampling factor.

11. The system of claim 8, wherein said at least one node comprises a first node and a second node, wherein said first node has a first local model prediction horizon, wherein said second node has a second local model prediction horizon, and wherein the first local model prediction horizon is different than the second local model prediction horizon.

12. The system of claim 8, wherein each node is further configured to calculate the local model prediction horizon based on how quickly that node is able to adjust the power of the associated load.

13. The system of claim 12, wherein the local model prediction horizon is calculated for said at least one node such that a faster node will have a shorter local model prediction horizon than a slower node.

14. The system of claim 8, wherein the local model prediction horizon for said at least one node is a predetermined value stored in a memory device of said at least one node.

15. A node for use in controlling a distributed power system, said node having an associated load and communicatively coupled to an aggregator, said node comprising:
a memory device; and
a processor communicatively coupled to said memory device, said processor configured to, at each of a plurality of sample times recurring at a regular interval:
receive, from the aggregator, a global value, wherein the global value is calculated by the aggregator based on a specified aggregated power level received from an independent service operation, a condensed dataset including load-specific information for said node, and a control prediction horizon, wherein the control prediction horizon is a time period that is an integer multiple of the regular interval;
solve a local optimization problem based on the received global value and a local model prediction horizon for said node, wherein the local model prediction horizon for said node of said plurality of nodes is longer than the control prediction horizon; and
control the load based on the solved local optimization problem for said node.

16. The node of claim 15, wherein the local model prediction horizon for said node is equal to the control prediction horizon multiplied by an integral down-sampling factor, Kₚ.

17. The node of claim 16, wherein the control prediction horizon is discretized using the sampling time, and wherein the local model prediction horizon for said node is discretized using the sampling time multiplied by the down-sampling factor.

18. The node of claim 15, wherein said node has a first local model prediction horizon, wherein another node in the distributed power system has a second local model prediction horizon, and wherein the first local model prediction horizon is different than the second local model prediction horizon.

19. The node of claim 15, wherein said processor is further configured to calculate the local model prediction horizon based on how quickly said node is able to adjust the power of the associated load.

20. The node of claim 19, wherein the local model prediction horizon is calculated for said node such that a faster node will have a shorter local model prediction horizon than a slower node.
